(19) United States
(12) Patent Application Publication
(10) Pub. No.: US 2018/0066720 A1
(43) Pub. Date: Mar. 8, 2018

(54) Steering Knuckle With Integrated Brake Mounting Provisions

(71) Applicant: Hendrickson USA, L.L.C., Itasca, CA (US)

(72) Inventors: Damon E. Dilworth, Channahon, IL (US); Matthew J. Van Meter, Plainfield, IL (US); Michael P. Bloink, Romeoville, IL (US); Jennifer Y. Wu, Naperville, IL (US); Ashley T. Dudding, Yorkville, IL (US)

(21) Appl. No.: 15/559,788

(22) PCT Filed: Mar. 18, 2016
(86) PCT No.: PCT/US16/23112

§ 371 Date: Sep. 19, 2017

Related U.S. Application Data
(60) Provisional application No. 62/136,308, filed on Mar. 20, 2015.

(51) Int. Cl. F16D 65/00; B62D 7/18; B62D 7/20

(52) U.S. Cl. CPC F16D 65/0062; B62D 7/20; B62D 7/18

(57) ABSTRACT

Steering knuckles integrating a brake mounting provisions are disclosed. The steering knuckles include a first, second piece and spindle. The first piece includes first and second mounting arms and each arm includes brake assembly engagement surfaces and brake assembly mounting bores, each of which can be modified to accommodate a number of different ways of removably connecting either a disc brake or drum brake to a steering knuckle.

### RELATED APPLICATIONS

This application claims the benefit of and priority of U.S. Provisional Patent Application Ser. No. 62/136,308, filed Mar. 20, 2015, the contents of which are incorporated by reference herein.

### DESCRIPTION

### Technical Field

The present disclosure relates generally to steering knuckle and brake assemblies for wheeled vehicles. More particularly, the present subject matter relates to the integration of foundation brake assembly elements into steering knuckles to directly and removably connect disc brake and drum brake assemblies to a steering knuckle. The disclosure presents several example embodiments that may be utilized for particular purposes.

### BACKGROUND

In a conventional heavy duty brake system, disc brake and drum brake assemblies are secured to a vehicle suspension system through the use of a separate brake foundation element, such as a torque plate in the case of a disc brake assembly and a brake spider in the case of a drum brake assembly. Conventional use of a separate brake foundation element to secure the disc or drum brake assembly, particularly on a steering axle, has limited the ability to reduce the weight and volume of steering and brake assemblies, and has shortcomings in terms of the complexity of their installation, maintenance and repair. It may also preclude the use of smaller rotor and brake assemblies.

### SUMMARY

There are several aspects of the present subject matter which may be embodied separately or together in the devices and systems described and claimed herein. These aspects may be employed alone or in combination with other aspects of the subject matter, and the description of these aspects together is not intended to preclude the use of these aspects separately or the claiming of such aspects separately as set forth in the claims appended hereto.

In an aspect of this disclosure, a steering knuckle comprises a first piece and a second piece. The first piece includes a first king pin bore, a first mounting surface and first and second brake mounting arms. The second piece includes a second king pin bore and a second mounting surface. The first and second mounting surfaces, at least one of which is generally arcuate in shape, engage one another to connect the first piece to the second piece. The first and second brake mounting arms, each having a proximal and distal portion, are configured for direct connection to a brake assembly. Axial and non-axial (and in particular radial) mounting of either a disc or drum brake assembly can be achieved.

In another aspect of this disclosure, a steering knuckle comprises a first piece, a second piece and a spindle. The first piece includes first and second mounting arms, each having a proximal and distal portion. Each arm includes brake assembly engagement surfaces and brake assembly mounting bores. The first and second mounting arm distal portions are configured for direct connection to a brake assembly. Axial and non-axial (and in particular radial) mounting of either a disc or drum brake assembly can be achieved.

### BRIEF DESCRIPTION OF THE DRAWINGS

In describing the preferred examples, reference is made to the accompanying drawing figures wherein like parts have like reference numerals, and wherein:

FIG. 1 is an upper front perspective view of a two piece steering knuckle with integrated brake mounting provision configured for axial mounting of a disc brake according to an aspect of the present disclosure;

FIG. 2 is an upper rear perspective rear view of the embodiment shown in FIG. 1;

FIG. 3 is an exploded upper front perspective view of the embodiment shown in FIGS. 1-2;

FIG. 4 is an exploded upper rear perspective view of the embodiment shown in FIGS. 1-2;

FIG. 5 is a side elevational view of a conventional steering knuckle with spindle;

FIG. 6 is a side elevational view of a steering knuckle with integrated mounting provision similar to FIGS. 1-4;

FIG. 7 is a left side, upper rear perspective view of a disc brake axially mounted to the two piece steering knuckle with integrated brake mounting provision of FIGS. 1-4;

FIG. 8 is a right side, upper rear perspective view of the embodiment shown in FIG. 7;

FIG. 9 is a left side, upper rear perspective view of the steering knuckle and disc brake of FIG. 8, mounted to an axle;

FIG. 10 is an exploded view of the embodiment shown in FIG. 9.

FIG. 11 is a right side, upper front perspective views of an axle fitted with left and right side steering knuckles with integrated brake mounting;

FIG. 12 is a left side, upper front perspective view of a two piece steering knuckle with integrated brake mounting for non-axial, and in particular, radial mounting of a disc brake according to an aspect of the present disclosure;

FIG. 13 is a right side, upper rear perspective view of the embodiment shown in FIG. 12;

FIG. 14 is a right side, upper front perspective view of a two piece steering knuckle with integrated brake mounting provision with an axially mounted drum brake assembly according to an aspect of the present disclosure;

FIG. 15 is a right side, upper rear perspective view of the embodiment shown in FIG. 14;

FIG. 16 is a left side, upper rear perspective view of the embodiment shown in FIGS. 14-15;

FIG. 17 is a front elevational view of the embodiment shown in FIGS. 14-16 without steering knuckle assembly fasteners;

FIG. 18 is a right side, upper rear perspective view of the embodiment shown in FIG. 17 with select components in exploded format;

FIG. 19 is a right side, upper front perspective view of a two piece steering knuckle with integrated brake mounting provision with a non-axial, and in particular, a radial mounted drum brake assembly according to an aspect of the present disclosure;

FIG. 20 is a right side, upper rear perspective view of the embodiment shown in FIG. 19.

### DETAILED DESCRIPTION OF THE ILLUSTRATED EMBODIMENTS

The embodiments disclosed herein are for the purpose of providing a description of the present subject matter, and it is understood that the subject matter may be embodied in various other forms and combinations not shown in detail. Therefore, specific designs and features disclosed herein are not to be interpreted as limiting the subject matter as defined in the accompanying claims.

Steering knuckles of the present disclosure provide an integrated brake mounting provision in the steering knuckle to allow for a direct, removable connection between a disc or drum brake assembly and the steering knuckle. The direct connection avoids the need for a separate torque plate or brake spider, which typically is a required foundation element of a conventional brake assembly. Integrating the torque plate (in the case of a disc brake assembly) or brake spider (in the case of a drum brake assembly) into the steering knuckle in the manner disclosed herein, simplifies the installation, maintenance and repair of steering and brake assemblies. It also reduces the size and weight of related componentry and unsprung vehicle weight, and improves structural integrity and positioning accuracy relative to prior art multicomponent assemblies. This may result in improved vehicle handling, fuel consumption, and/or brake performance and wear characteristics. It should be understood that steering knuckles with an integrated brake assembly mounting provision according to the present disclosure also may be provided with separate or additional brake mounting componentry, without departing from the present disclosure.

The illustrated and example steering knuckles of the present disclosure are comprised of two components. The first piece 20 may be referred to as the knuckle body or backbone. The second piece 40 may be referred to as the upper yolk arm or steering arm or upper steering knuckle piece. While the illustrated and example steering knuckles are comprised of two pieces, it is within the scope of the present disclosure for the steering knuckle to be formed as a single piece or to be formed of three or more components.

It will be appreciated that steering knuckle components of the present disclosure, including first piece 20 and second piece 40, may be constructed from various materials including steel, ductile iron, aluminum, alloys or other suitable substantially rigid materials. It will also be appreciated that the pieces may be manufactured by any suitable method, such as by casting, forging, machining or the like. The same material and/or method of manufacturing need not be used for each piece. Manufacturing of knuckle componentry also may include machining, for example, to drill and/or tap bores or to flatten engagement surfaces, as further discussed herein.

Additionally, while steering knuckles of the present disclosure are intended for use with a fixed king pin, it is also within the scope of the present disclosure for them to be used with removable king pin designs.

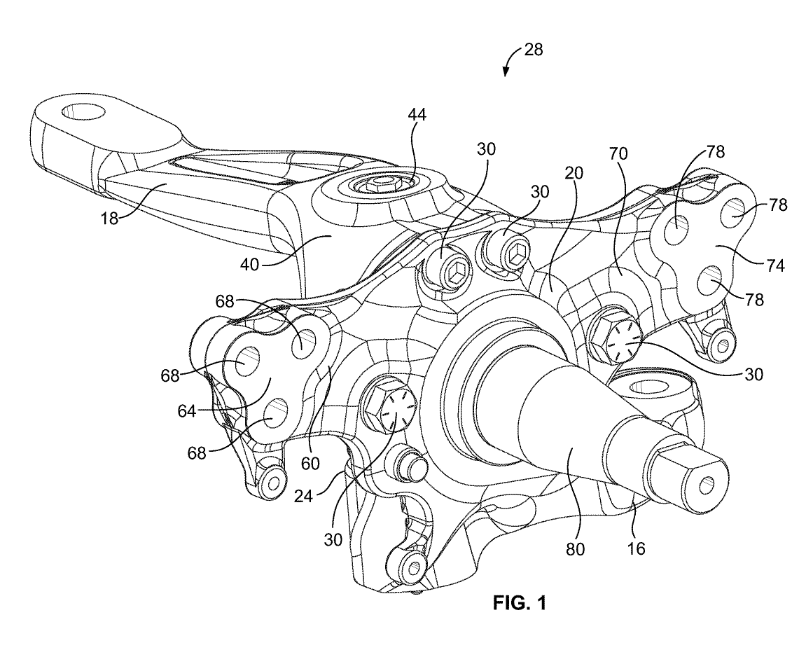

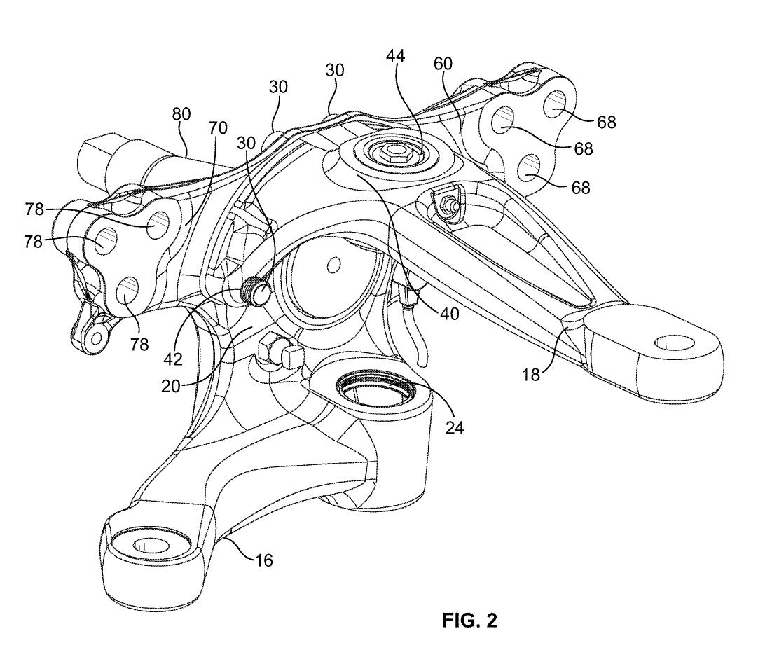

As shown in FIGS. 1-4, an example steering knuckle 28 has a vertical portion that contains integrated brake mounting arms 60, 70 that allow for direct connection of a disc brake assembly. The first piece 20 defines a plurality of axially oriented bores 22,68,78,84 and a generally vertical, first king pin bore 24, referred to as a steering pivot axis bore. As used herein, the term “axially” (and variations thereof) is used to refer to a direction at least substantially parallel to the central axis of a spindle. In contrast, the term “non-axially” (and variations thereof) refers to a direction that is not at least substantially parallel to the central axis of the spindle, while the term “radially” (and variations thereof) refers to a direction that is at least substantially perpendicular to the central axis of the spindle.

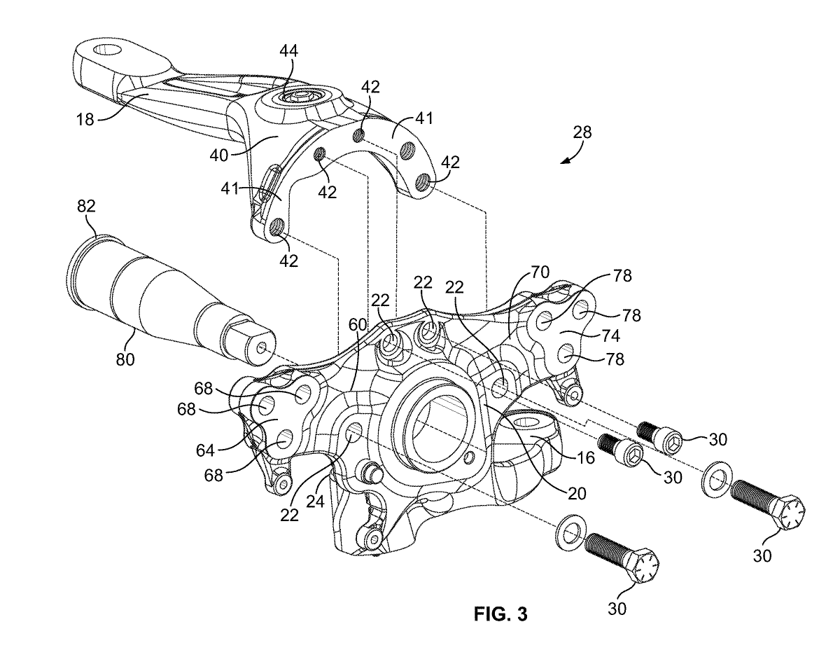

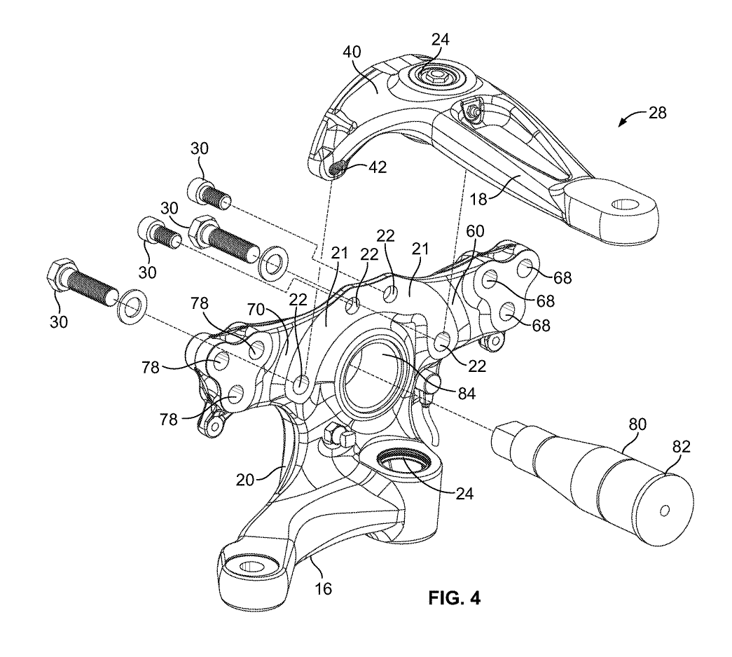

As shown in FIGS. 3-4, among the axially oriented bores is a spindle retaining bore 84 configured to receive a press fit spindle 80, which is preferably constructed of a high strength material, such as premium steel or the like. In the example shown in FIGS. 3-4, the spindle 80 includes a shoulder 82 at its base which provides a stop when fitting the spindle into a counter bore on the inboard side of the first piece 20. This arrangement prevents the spindle 80 from walking out if the retention provided by the press fitting were to fail. Alternatively, the first piece 20 could be formed integrally with the spindle 80.

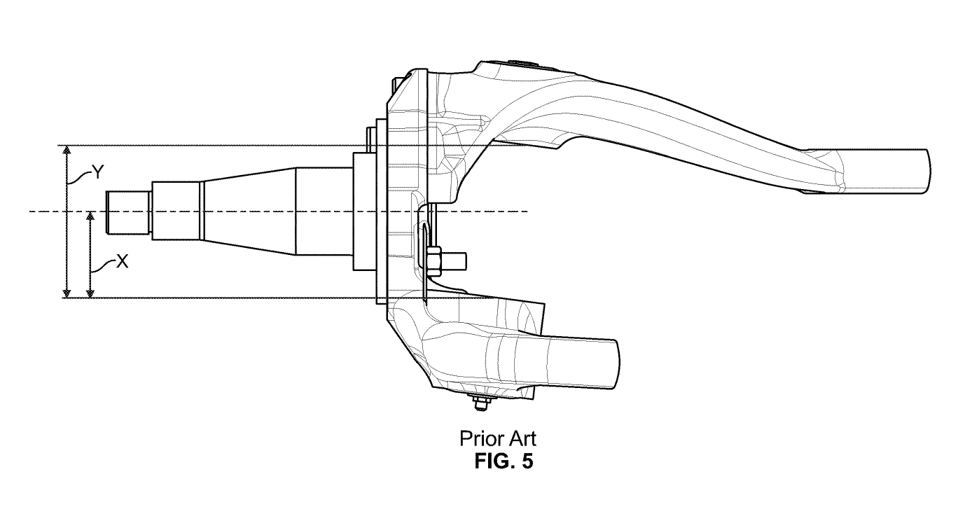

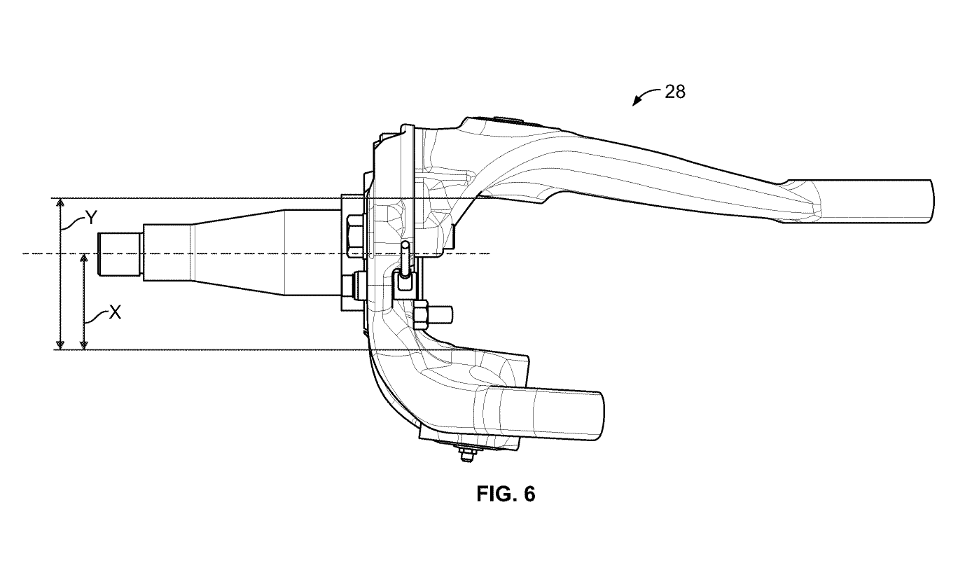

As may be seen in FIGS. 5-6, the position of the spindle 80 within the steering knuckle may be modified relative to conventional designs. In the embodiment of FIG. 5, the distance (X) from the central axis of the spindle to the top of the lower king pin bushing is 74 mm, which is 63% of the 116 mm of the distance (Y) from the bottom surface of the upper king pin bushing to the top surface of the lower king pin bushing. The respective distances and ratio in the prior art design (FIG. 5) is 64 mm/116 mm or 56%. Thus, the spindle 80 is located further from the top of the lower king pin bushing relative to the conventional design. This permits greater clearance of the brake caliper over the top surface of the steering knuckle 28 during wear of the brake pads.

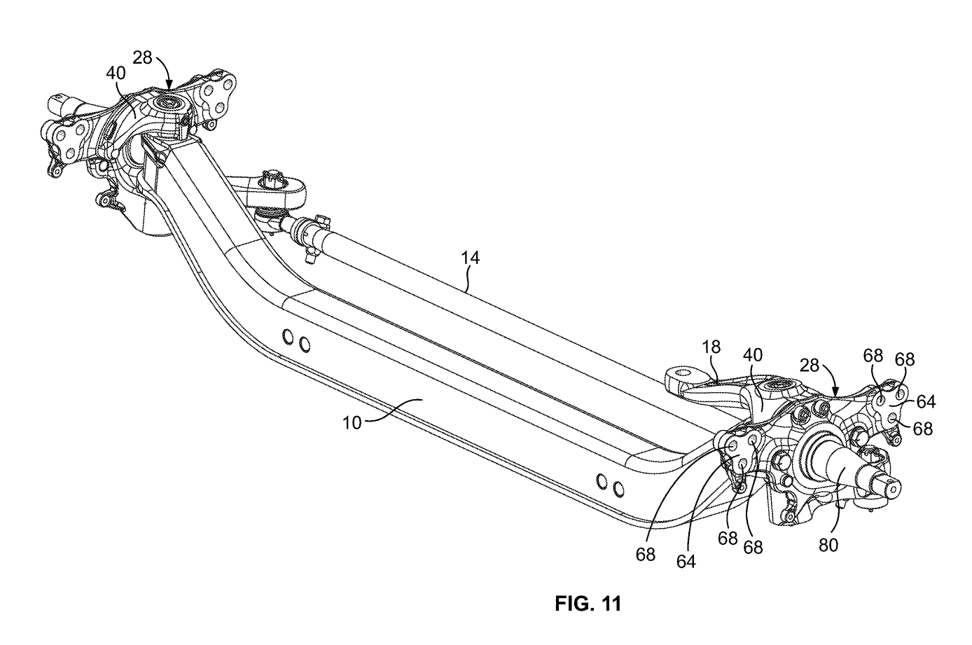

In addition to the various bores 22, the first piece 20 may also include an integral tie rod arm, also referred to as an Ackerman arm 16 (FIG. 4), which is configured for connection to a tie rod 14 (FIG. 11). During use, the tie rod 14 connects a left side steering knuckle and a right side steering knuckle (FIG. 11). Left and right side steering knuckles associated by a tie rod may be substantially identical mirror images or may be differently configured.

The second piece 40 includes a second king pin bore 44 and a generally arcuate shaped mounting surface 41 providing a plurality of axially oriented assembly bores 42 (FIG. 3). A generally arcuate shaped mounting surface 21 in first piece 20 (FIG. 4) provides axially oriented assembly bores 22 configured in registration with second piece assembly bores 42, and enable the first piece 20 to be removably connected to the second piece 40 by fasteners. Bores 42 of the example second piece 40 may be internally threaded to mate with externally threaded mechanical fasteners 30, however, it will be appreciated that a removable connection between the first and second pieces 20, 40 may be achieved with hex nuts and bolts, according to the pattern shown in FIG. 3, or with other suitable numbers and types of fasteners, fastener patterns or methods of connection. Any of the fastener patterns described or illustrated herein may be used with any of the example steering knuckles without departing from the scope of the present disclosure.

A permanent or nonremovable connection also could be achieved with a steering knuckle of the present disclosure by welding or forging the first and second pieces together. This, however, would require that the steering knuckle be used with a removable king pin to permit servicing and repair of the steering knuckle assembly and king pin assembly.

The first piece 20 also provides a first mounting arm 60 and a second mounting arm 70 with each having a proximal and distal portion. As used herein, the terms “proximal” and “distal” refer to the distance from the spindle to the portion of the arm. Each mounting arm 60, 70 provides one or more brake assembly engagement surfaces 64, 74 and one or more brake assembly mounting bores 68, 78 to removably connect the brake assembly to the steering knuckle with the use of mechanical fasteners 72. In the preferred example steering knuckle 28, directed to axial mounting of a disc brake assembly, first and second mounting arms 60, 70 extend fore and aft of the spindle 80 and reside in a plane substantially perpendicular to the central axis of the spindle. A vertical brake assembly engagement surface 64, 74 and axially oriented brake mounting bores 68, 78 are positioned in the distal portion of each mounting arm 69, 70.

It will be appreciated that by locating the end positions of the arcuate shaped, steering knuckle assembly mounting surfaces 21, 41 between the brake assembly engagement surfaces 64, 74 and the spindle 80, assembly mounting surfaces 21, 41 at least partially wrap around the central axis of the spindle 80, providing a compact but strong, assembled steering knuckle profile.

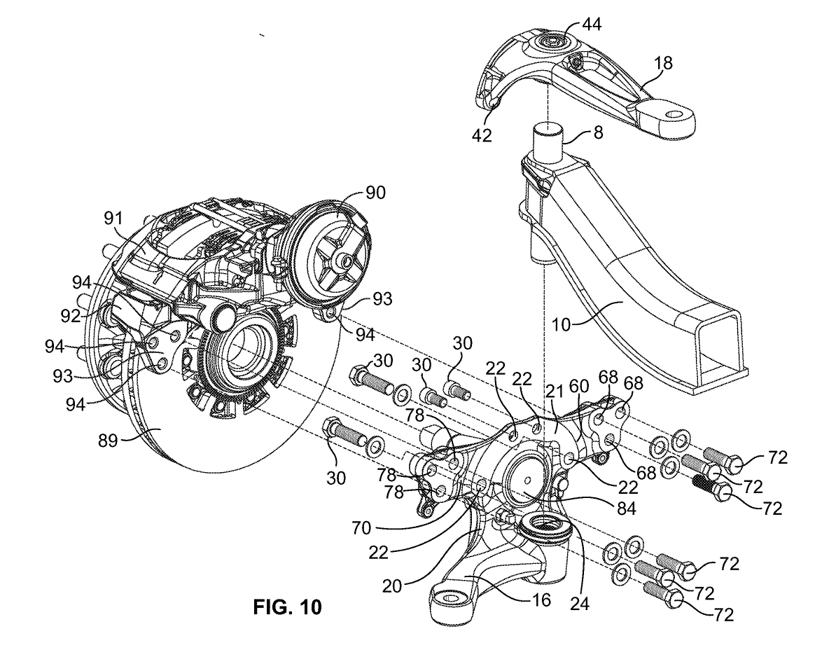

Brake assembly mounting bores 68, 78 are provided in registration with a plurality of mounting bores 94 in the carrier plate 93 on the brake carrier 92 to secure the air disc brake assembly 90 to the steering knuckle 28 with the use of mechanical fasteners 72, as shown in FIG. 10. It will be appreciated that the example steering knuckle to brake assembly connection utilizes three fasteners for each mounting arm, however, the brake carrier could be properly secured with fewer or more than three fasteners for each mounting arm without departing from the present disclosure.

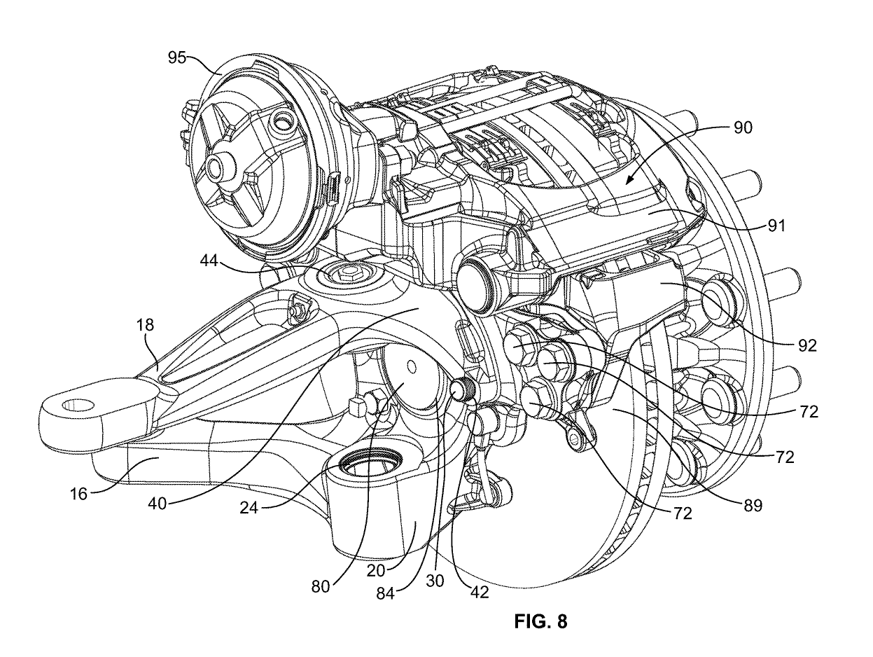

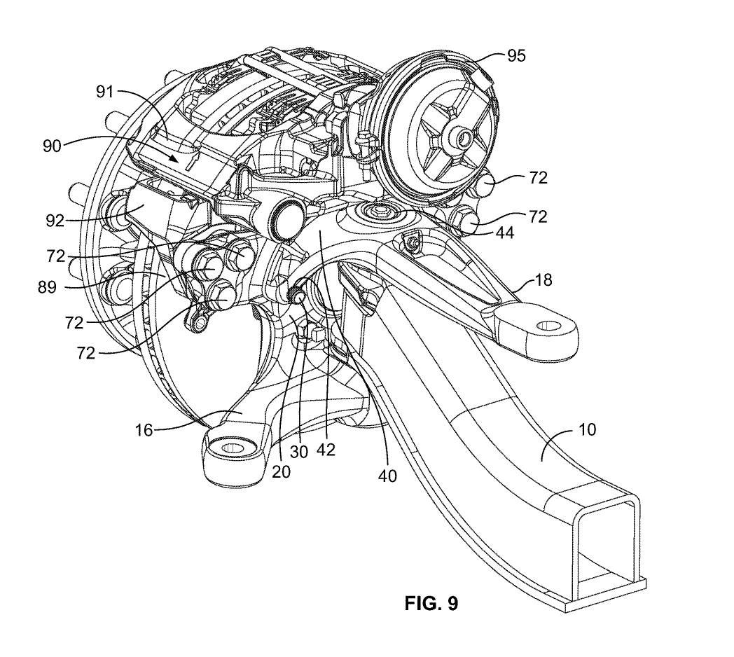

It should be understood that the exact configuration of the steering knuckles shown in FIGS. 1-4 and 6-13 are merely exemplary and that steering knuckles for axially mounting a disc brake may be configured differently without departing from the scope of the present disclosure.

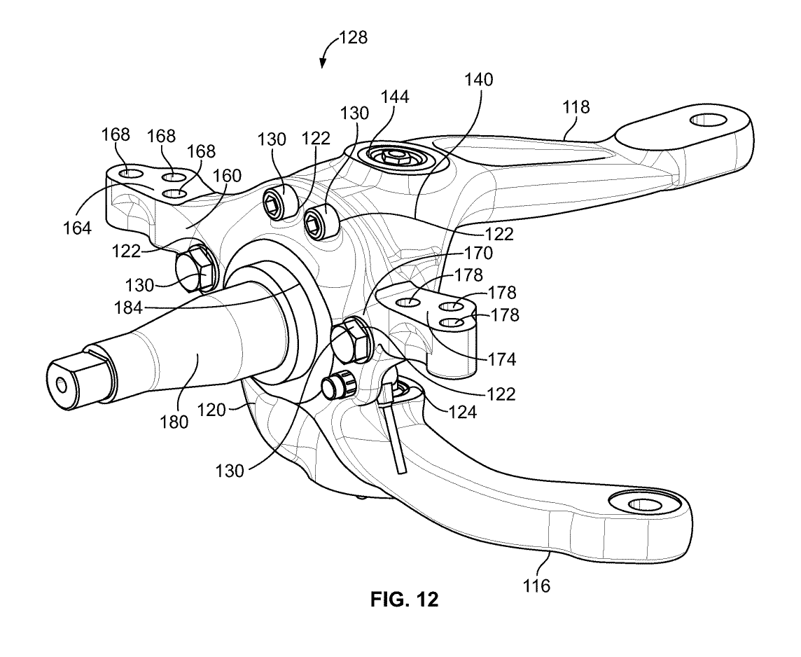

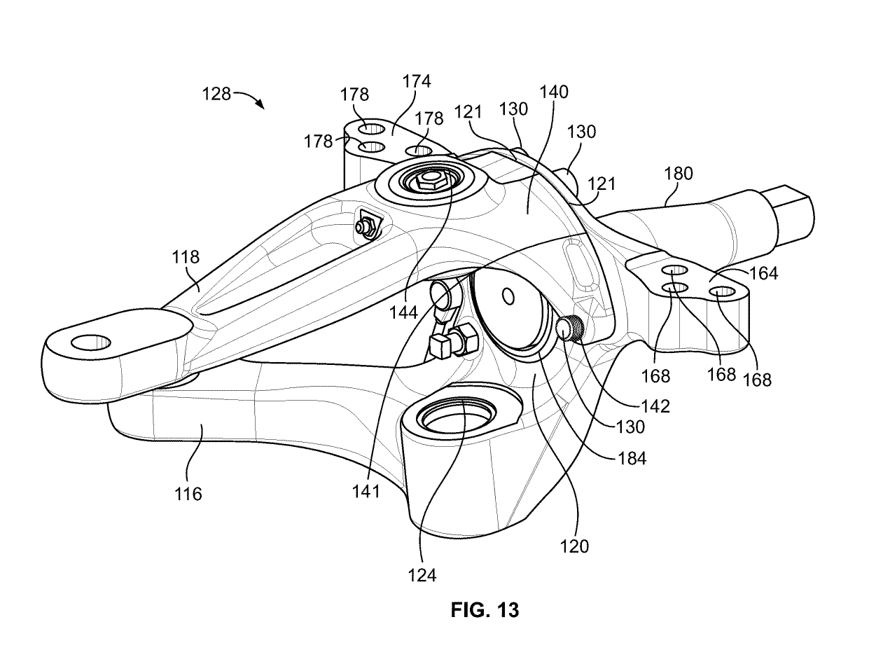

In FIGS. 12-13, another example steering knuckle 128 is shown. As with other example steering knuckles described and illustrated herein, example steering knuckle 128 is comprised of first and second pieces 120, 140. Corresponding generally arcuate shaped mounting surfaces 121, 141, of the respective first and second pieces 120, 140 provide axially oriented, assembly bores 122, 142. First piece assembly bores configured in registration with second piece assembly bores enable the first piece to be removably connected to the second piece with the use of suitable fasteners.

Example steering knuckle 128 also has first and second mounting arm brake assembly engagement surfaces 164, 174 that are substantially coplanar and generally equidistant from the central axis of the spindle bore 184. In this example, however, the brake assembly engagement surfaces 164, 174 and brake mounting bores 168, 178 are oriented respectively, horizontally and vertically. This example steering knuckle 128 may alternatively be referred to herein as providing for non-axial mounting of a brake assembly. In contrast, the example steering knuckle of FIGS. 1-4 and 7-10 has vertical brake assembly engagement surfaces 164, 174 and horizontal brake mounting bores 168, 178 and provides for axial mounting of a brake assembly.

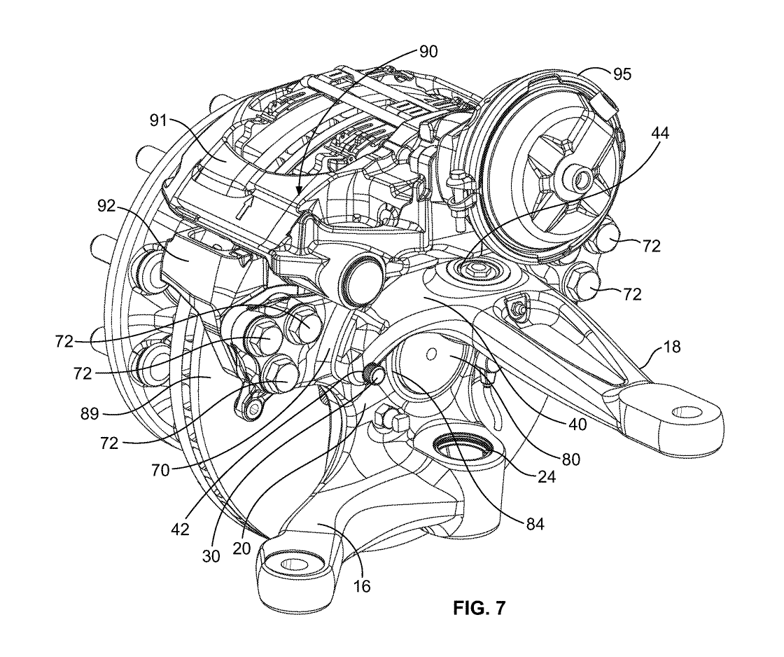

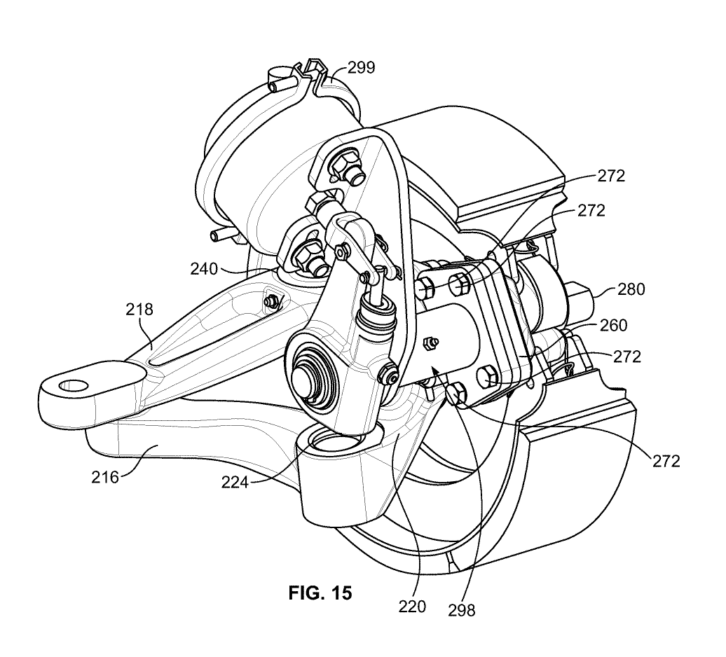

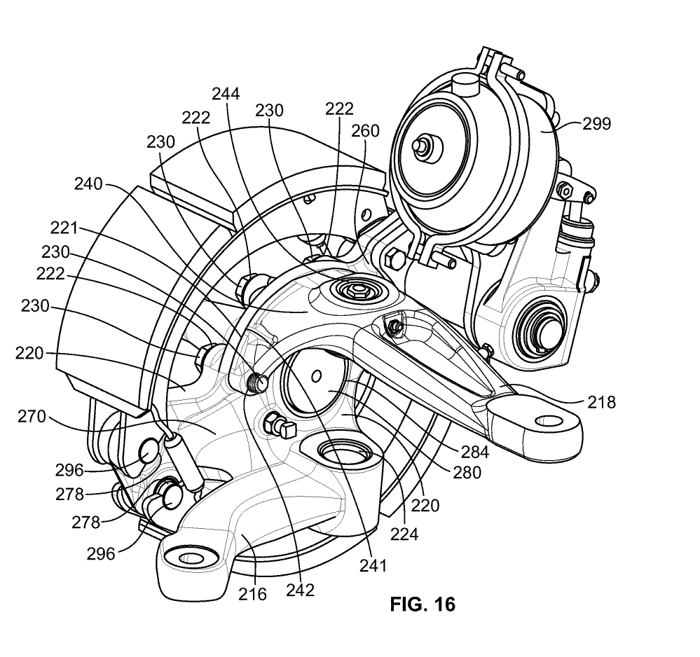

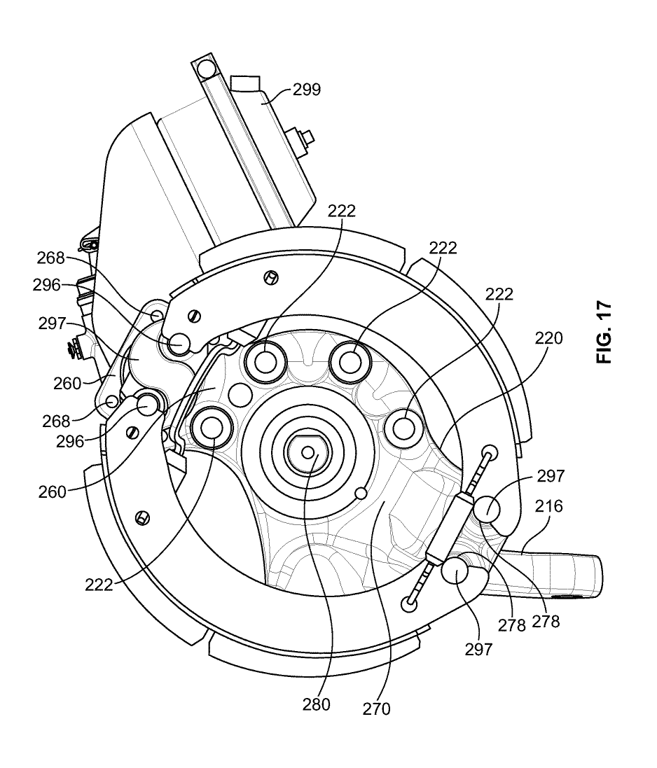

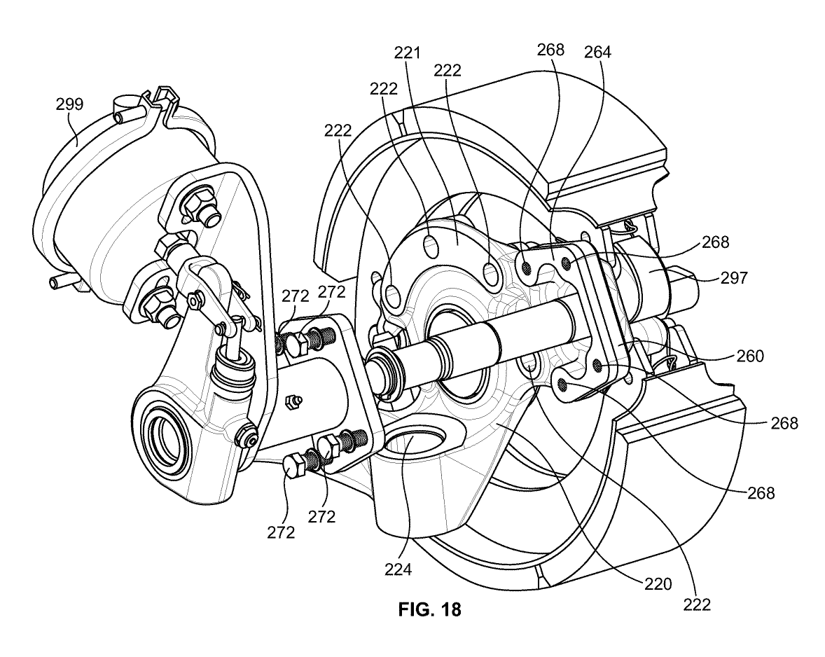

The unique construction of the example steering knuckles shown in FIGS. 1-4 and 6-20, which incorporate an integrated brake mounting provision, raised steering spindle and repositioned brake assembly, places the air chamber of the disc brake assembly in the twelve o'clock position to permit the example steering knuckles to accommodate smaller, more compact and lighter rotors and brake assemblies, such as for example, the 415 mm diameter rotor shown in FIGS. 7-10 or an even smaller 410 mm diameter rotor.

Steering knuckles of the present disclosure, whether configured for radial or axial mounting of a brake assembly, can be varied in a number of different ways. For example, first and second mounting arms may be provided at any angle greater than ninety degrees apart (vertex of angle measuring separation located on the central axis of the spindle bore). The first and second mounting arms could be positioned in the nine and three o'clock, or alternatively, in the twelve and six o'clock positions relative to the central axis of the spindle bore.

As a further example, any of the foregoing example steering knuckles could have any of their first and second mounting arms or brake assembly engagement surfaces positioned above, even with or below the central axis of the spindle.

As a further example, any of the foregoing example steering knuckles could have first and second brake assembly engagement surfaces which reside in the same plane or parallel planes. First and second mounting arm brake assembly engagement surfaces may also be positioned at different distances from the central axis of the spindle bore. Still further, first and second mounting arm brake assembly engagement surfaces may be positioned in intersecting planes when angled toward or away from one another.

Steering knuckles of the present disclosure also may be configured to accommodate a drum brake assembly.

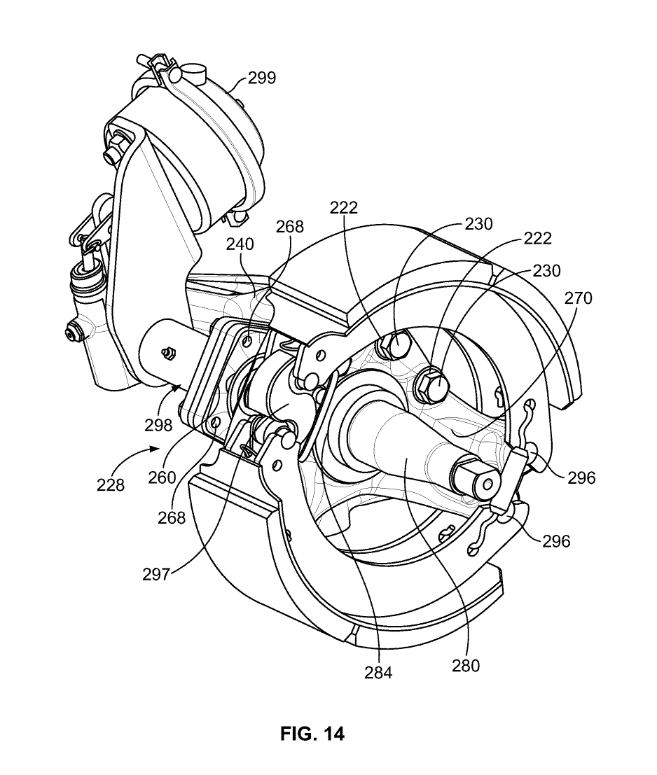

Separate example steering knuckles 228, 328, comprised of at least two pieces, removably connected to a drum brake assembly, are shown respectively in FIGS. 14-18 and 19-20.

In these additional illustrated embodiments of a two-piece steering knuckle 228, 328, the first piece 220, 320 may be referred to as the knuckle body or backbone and defines a plurality of axially oriented bores 222, 268, 278, 284; 322, 368, 378, 384 and a generally vertical first king pin bore 224, 324. One of the axially oriented bores 284, 384 receives a spindle 280, 380. Two of the axially oriented bores receive anchor pins 296, 396.

The second piece 240, 340 may be referred to as the upper yolk arm, steering arm or upper steering knuckle piece, and includes a second king pin bore 224, 324. Corresponding generally arcuate shaped mounting surfaces 221, 241; 321, 341 of respectively the first and second pieces 220, 240; 320, 340 provide axially oriented, assembly bores 222, 242; 322, 342. First piece assembly bores 222, 322 are configured in registration with second piece assembly bores 242, 342 and enable the first piece 220, 320 to be removably connected to the second piece 240, 340 by mechanical fasteners 230, 330.

The first piece 220, 320 also provides a first mounting arm 260, 360 and a second mounting arm 270, 370, each having a proximal and distal portion. One or both of the first and second mounting arms 260, 270; 360, 370 also provide one or more brake assembly engagement surfaces 264, 364 and one or more brake mounting bores 268, 278; 368, 378 to removably connect the brake assembly to the steering knuckle with the use of mechanical fasteners 272, 297; 368, 396.

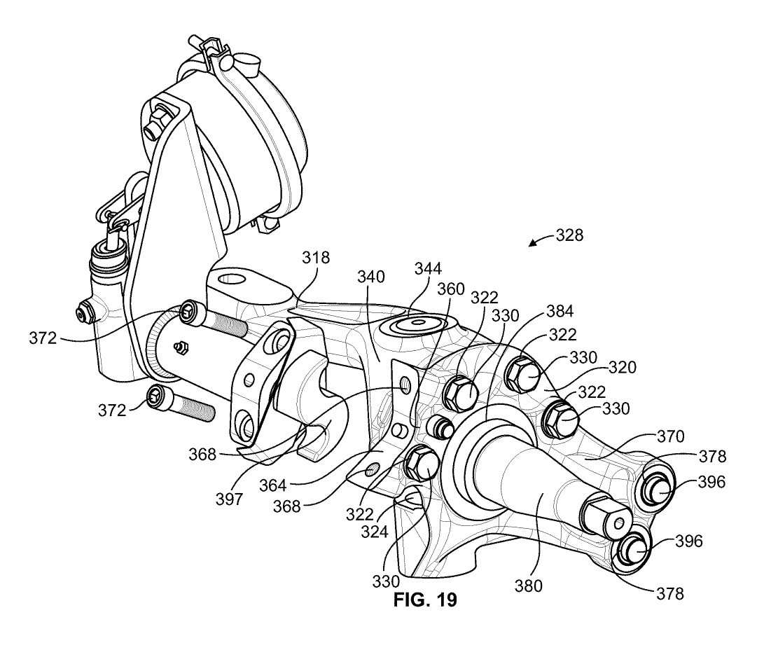

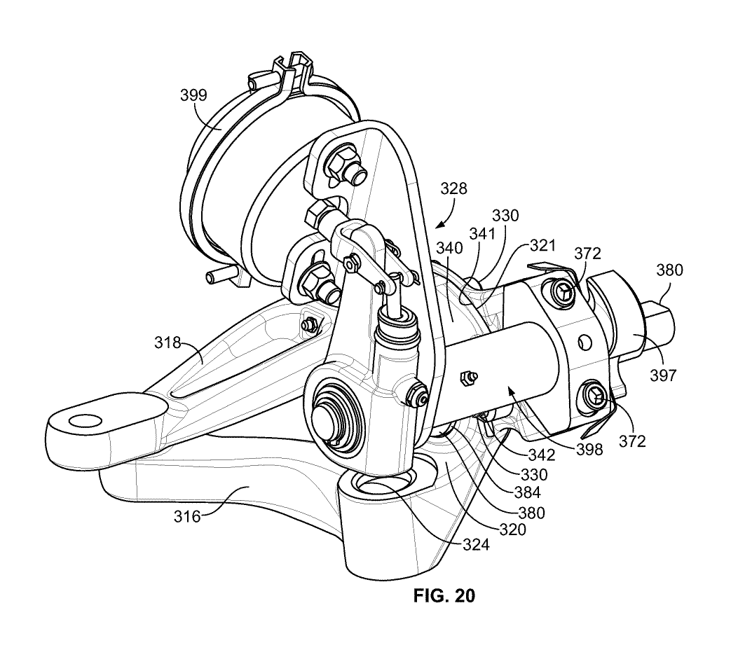

A disk brake S-cam assembly can be removably connected to the example steering knuckles through a variety of different methods within the scope of the present disclosure. Under the axial approach (FIG. 14-18), the S-cam assembly is removably connected to an example knuckle assembly mounting arm by axially oriented fasteners. Alternatively, under the non-axial approach (FIG. 19-20), the S-cam assembly is secured to an example knuckle assembly mounting arm by fasteners that are oriented in a direction that is not at least substantially parallel to the central axis of the spindle. Within the latter category is the radial approach (FIG. 19-20) wherein the S-cam is secured by fasteners oriented in a direction that is at least substantially perpendicular to the central axis of the spindle (referred to as a “radial” connection”). In all of the foregoing examples, the non S-Cam assembly mounting arm utilizes axially orient anchor pins or fasteners 297, 397.

Multiple embodiments illustrating different techniques, including those described and illustrated herein, to removably connect an S-cam assembly with a steering knuckle, including a two piece steering knuckle, are the subject of co-filed U.S. Patent Application Ser. No. 62/136,040, entitled “Alternative Approaches to Mounting the S-CAM Tube of a Vehicle Brake Assembly” (Attorney Docket No.: 0715-0222), the entirety of which has been incorporated herein by reference.

It will be understood that the embodiments described above are illustrative of some of the applications of the principles of the present subject matter. Numerous modifications may be made by those skilled in the art without departing from the spirit and scope of the claimed subject matter, including combinations of features that are individually disclosed or claimed herein. For these reasons, the scope of this disclosure is not limited to the above description but is as set forth in the following claims, and it is understood that claims may be directed to the features hereof, including as combinations of features that are individually disclosed or claimed herein.

We claim:

1. A steering knuckle for use in association with a vehicle steering axle assembly and brake assembly, comprising:
a first piece having a first king pin bore, said first king pin bore extending in a first direction and configured to receive a first portion of a king pin;
a second piece having a second king pin bore, said second king pin bore extending in a first direction and configured to receive a second portion of a king pin;
wherein said first piece includes a first mounting surface and said second piece includes a second mounting surface, at least one of said mounting surfaces being generally arcuate in shape, and said first and second mounting surfaces engage one another to connect said first piece to said second piece; and wherein said first piece further includes first and second mounting arms, each having a proximal and distal portion, and the distal portions of the first and second mounting arms are configured for direct connection to a brake assembly.

2. The steering knuckle of claim 1 further comprising a spindle, said spindle having a central axis extending in a second direction that is generally perpendicular to said first direction.

3. The steering knuckle of claim 2 wherein said steering knuckle includes a spindle bore, said spindle received within said spindle bore.

4. The steering knuckle of any one of claim 1-3 wherein said first piece includes a tie rod arm.

5. The steering knuckle of claim 4 wherein said tie rod arm is integrally formed with said first piece.

6. The steering knuckle of any one of claims 1-5 wherein said second piece includes a steering arm.

7. The steering knuckle of claim 6 wherein said steering arm is integrally formed with said second piece.

8. The steering knuckle of any one of claim 1-7 comprising a fastener connecting said first piece to said second piece.

9. The steering knuckle of claim 2 wherein said first and second mounting surfaces wrap at least partially around the central axis of the spindle.

10. The steering knuckle of any one of claims 1-9 wherein the other one of the first and second mounting surfaces is generally arcuate in shape, each of said mounting surfaces provides a plurality of bores, and the plurality of bores associated with the first piece and the plurality of bores associated with the second piece are configured in registration with one another.

11. The steering knuckle of claim 10 wherein at least one of the plurality of bores associated with the first mounting surface or the second mounting surface is threaded and configured to receive a threaded fastener.

12. The steering knuckle of any one of claims 1-11 wherein a portion of the first mounting surface or the second mounting surface is positioned above the first or second mounting arm.

13. The steering knuckle of any one of claims 1-12 wherein portions of the first mounting surface and the second mounting surface are positioned above the first mounting arm and the second mounting arm.

14. The steering knuckle of any one of claims 1-13 wherein the distal portion of the first mounting arm or the distal portion of the second mounting arm has at least one brake assembly mounting bore.

15. The steering knuckle of any one of claims 1-14 wherein the distal portions of the first mounting arm and the second mounting arm collectively have two or more brake assembly mounting bores.

16. The steering knuckle of claim 15 wherein said two or more brake assembly mounting bores are generally perpendicular to said first direction.

17. The steering knuckle of claim 15 wherein said two or more brake assembly mounting bores are substantially parallel to one another.

18. The steering knuckle of claim 15 wherein said two or more brake assembly mounting bores are not substantially parallel to one another.

19. The steering knuckle of any one of claims 1-18 wherein the distal portion of at least one of the first mounting arm or the second mounting arm has a brake assembly engagement surface that is generally parallel to said first direction.

20. The steering knuckle of any one of claims 1-19 wherein the distal portion of at least one of the first mounting arm or second mounting arm has a brake assembly engagement surface that is not generally parallel or is generally perpendicular to said first direction.

21. The steering knuckle of any one of claims 1-20 wherein the distal portions of the first mounting arm and the second mounting arm have brake assembly engagement surfaces that are generally parallel to one another or to said first direction.

22. The steering knuckle of any one of claims 1-21 configured for direct connection to a disc brake assembly or to a drum brake assembly.

23. The steering knuckle of any one of claims 1-22 configured for connection to a rotor having a 415 mm or smaller diameter.

24. The steering knuckle of claim 2 wherein the ratio of the distance between the top of the first king pin bore and the central axis of the spindle, and the distance between the top of the first king pin bore and the bottom of the second pin bore is greater than fifty six percent.

25. The steering knuckle of claim 24 wherein said ratio is approximately sixty three percent.

26. The steering knuckle of any one of claims 1-21, 23 and 25 wherein the first and second mounting arms are configured for direct connection to a disk brake assembly.

27. The steering knuckle of any one of claims 1-21, 23 and 25 wherein the first and second mounting arms are configured for direct connection to a drum brake assembly.

28. A steering knuckle for use in association with a vehicle steering axle assembly and brake assembly, comprising:
a first piece having a first king pin bore extending therethrough;
a second piece connected to the first piece, the second piece having a second king pin bore extending therethrough; and
a spindle connected to the first piece and having a central axis; and
wherein the first piece further includes first and second mounting arms, each having a proximal and distal portion, and wherein the first and second mounting arm distal portions are configured for direct connection to a brake assembly.

29. The steering knuckle of claim 28 wherein the first piece is removably connected to the second piece.

30. The steering knuckle of claim 28 wherein the first and second mounting arm distal portions each have at least one brake assembly mounting bore.

31. The steering knuckle of claim 30 wherein the brake assembly mounting bores of the first and second mounting arms are parallel to the central axis of the spindle.

32. The steering knuckle of claim 30 wherein the brake assembly mounting bores are perpendicular to the central axis of the spindle.

33. The steering knuckle of any one of claims 28-32 wherein the first and second mounting arms are configured for direct connection to a disc brake assembly.

34. The steering knuckle of claim 33 wherein the first and second mounting arms are configured for connection to a rotor having a diameter of 415 mm.

35. The steering knuckle of any one of claims 28-32 wherein the first piece is removably connected to a drum brake assembly.

36. The steering knuckle of any one of claims 28-35 wherein the second piece further comprises a steering arm.

37. The steering knuckle of any one of claims 28-35 wherein the second piece further comprises an integrated Ackerman arm or a tie rod arm.
